(19) United States
(12) Patent Application Publication
(10) Pub. No.: US 2024/0367566 A1
(43) Pub. Date: Nov. 7, 2024

(54) Armrest Swing Hinge Device

(71) Applicant: Daechang Seat Co., LTD - Dongtan, Hwaseong-si (KR)

(72) Inventor: In Chang Hwang, Hwaseong-si (KR)

(21) Appl. No.: 18/624,552

(22) Filed: Apr. 2, 2024

(30) Foreign Application Priority Data
May 4, 2023 (KR) 10-2023-0058501

(51) Int. Cl. B60N 2/75

(52) U.S. Cl. CPC B60N 2/773; B60N 2/767

(57) ABSTRACT

Proposed is an armrest swing hinge device, wherein the hinge device includes a bracket housing coupled to a side of a seat frame and provided with a pivoting space therein, a vertical shaft penetrating through the pivoting space of the bracket housing in the up and down direction, a pivoting housing pivotably provided in the pivoting space of the bracket housing in a state of being coupled to the vertical shaft, and a horizontal shaft provided perpendicular to the vertical shaft on an outer surface of the pivoting housing, exposed to the outside of the bracket housing, and coupled to an armrest in a manner that orients the armrest to face forward.

### CROSS REFERENCE TO RELATED APPLICATION

The present application claims priority to Korean Patent Application No. 10-2023-0058501, filed on May 4, 2023, the entire contents of which is incorporated herein for all purposes by this reference.

### BACKGROUND

### Technical Field

The present disclosure relates to an armrest swing hinge device that connects a seat of a second row and an armrest of a vehicle.

### Description of the Related Art

An example of an armrest swing hinge device is disclosed in Korean Patent Publication No. 10-1518956 (title: armrest hinge device for vehicle seat, hereinafter referred to as “conventional armrest swing hinge device”).

In an armrest swing hinge device for a vehicle seat, wherein the hinge device is configured to fold or unfold an armrest that is installed on a seatback, which is a backrest of an occupant in a rear seat of a vehicle, and to enable an occupant to rest an arm, the conventional armrest swing hinge device includes: a hinge bracket mounted in a laying groove provided in the seatback and having first and second through holes provided on one upper side and one central side, respectively, corresponding to the armrest; an armrest frame provided inside the armrest and having first and second hinge protrusions provided to be apart at a regular interval on upper and lower parts of a lower end region corresponding to the hinge bracket, respectively; a first link having one end hinge-connected to the first hinge protrusion of the armrest frame and an opposite end hinge-connected to the first through hole of the hinge bracket on one surface of the hinge bracket facing the armrest frame through a first hinge pin; a second link having one end hinge-connected to the second hinge protrusion of the armrest frame and an opposite end hinge-connected to the second through hole of the hinge bracket on one surface of the hinge bracket facing the armrest frame through a second hinge pin; and a lock having one end hinge-connected to the opposite end of the second link through the second hinge pin on the opposite surface of the hinge bracket and an opposite end hinge-connected to opposite end of the first link through the first hinge pin in the first through hole.

As illustrated in the example above, the conventional armrest swing hinge device is designed to allow pivoting in the up and down directions but to preclude pivoting to the left and right directions. However, as electric vehicles and autonomous driving technology develop, the need to increase the convenience of a seat of a second row is increasing. Therefore, it is necessary for the armrest swing hinge device, which connects the seat of the second row and armrest, to be designed to allow the armrest to be adjustable to the desired width, thereby enhancing user convenience while the user sits in the seat of the second row.

The foregoing is intended merely to aid in the understanding of the background of the present disclosure, and is not intended to mean that the present disclosure falls within the purview of the related art that is already known to those skilled in the art.

### DOCUMENTS OF RELATED ART

### Patent Document

(Patent Document 1) Korean Patent No. 10-1518956 B1 (Publication Date: May 12, 2015)

### SUMMARY

Accordingly, the present disclosure has been made keeping in mind the above problems occurring in the related art, and the present disclosure is intended to propose an armrest swing hinge device that connects a seat of a second row and an armrest, allowing the armrest to be pivotably moved to the left and right sides.

In order to achieve the above objective, there may be provided an armrest swing hinge device, and the armrest swing hinge device according to a present embodiment may include: a bracket housing coupled to a side of a seat frame and provided with a pivoting space therein; a vertical shaft penetrating through the pivoting space of the bracket housing in an up and down direction; a pivoting housing pivotably provided in the pivoting space of the bracket housing in a state of being coupled to the vertical shaft; and a horizontal shaft provided perpendicular to the vertical shaft on an outer surface of the pivoting housing such that the horizontal shaft is exposed to the outside of the bracket housing, and is coupled to an armrest in a manner that orients the armrest to face forward.

The pivoting housing of the armrest swing hinge device according to the present embodiment may include: a pivoting housing main body coupled to the vertical shaft; and a pivoting housing extension plate extended forward from the pivoting housing main body, and the bracket housing may include: a bracket housing main body coupled to a side surface of the seat frame; and a pivoting blocking plate extended forward from the bracket housing main body and configured to come into contact with the pivoting housing extension plate configured to pivot outward of the seat frame.

The armrest swing hinge device according to the present embodiment may further include an elastic body disposed in the pivoting housing in a type of surrounding an outer circumference of the vertical shaft, the elastic body having one side supporting the bracket housing and an opposite side supporting the pivoting housing.

The bracket housing of the armrest swing hinge device according to the present embodiment may include a bushing surrounding an outer circumference of the vertical shaft.

The pivoting housing of the armrest swing hinge device according to the present embodiment may include a damper provided at an end part of the pivoting housing extension plate.

As described above, In the armrest swing hinge device according to the embodiment, the combined armrest can be pivotably moved to the left and right sides, thereby improving user convenience.

The armrest swing hinge device according to the embodiment can be adjusted to suit the user's physique.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view showing an armrest swing hinge device according to an embodiment, the device being coupled to a seat frame of a second row and an armrest;

FIG. 2 is a perspective view showing the armrest swing hinge device according to the embodiment, the device being coupled to the armrest;

FIG. 3 is an exploded view of the armrest swing hinge device according to the embodiment; and

FIGS. 4A and 4B are each a sectional view showing an operation of the armrest swing hinge device according to the embodiment.

### DETAILED DESCRIPTION

The advantages and features of the present disclosure, as well as methods for the achievement thereof, will become clear with reference to embodiments described in detail below, along with the accompanying drawings. However, the present disclosure is not limited to the embodiments disclosed below and may be implemented in various forms different from one another. The present embodiments are merely provided to ensure that the present disclosure is complete and to fully inform those skilled in the art to which the present disclosure pertains, and the present disclosure is defined solely by the scope of the claims. Like reference numerals refer to like elements throughout the specification.

With reference to the drawings below, an armrest swing hinge device 1 according to an embodiment (hereinafter referred to as “armrest swing hinge device 1”) will be described.

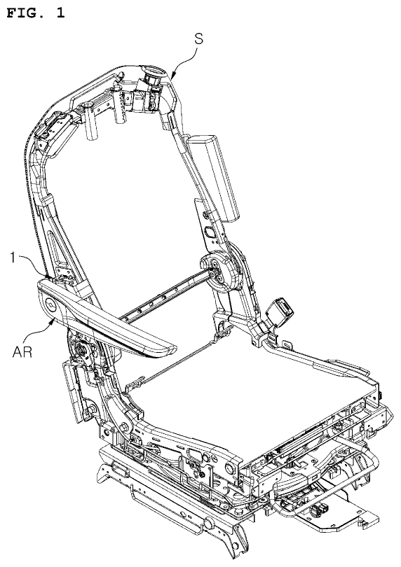

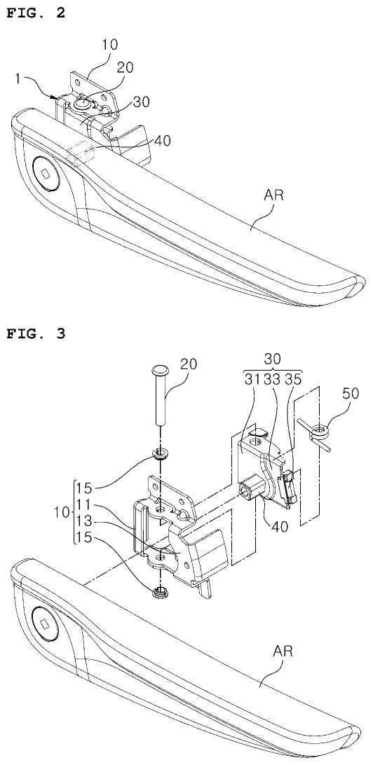

With reference to FIGS. 1 and 2, the armrest swing hinge device 1 includes a bracket housing 10, a vertical shaft 20, a pivoting housing 30, and a horizontal shaft 40, wherein the bracket housing 10 is coupled to a seat frame S, and an armrest AR is coupled to the horizontal shaft 40, wherein FIG. 1 is a perspective view showing the armrest swing hinge device 1 according to an embodiment, the device 1 being coupled to the seat frame S of a second row and to the armrest AR, and FIG. 2 is a perspective view showing the armrest swing hinge device 1 according to the embodiment, the device 1 being coupled to the armrest AR.

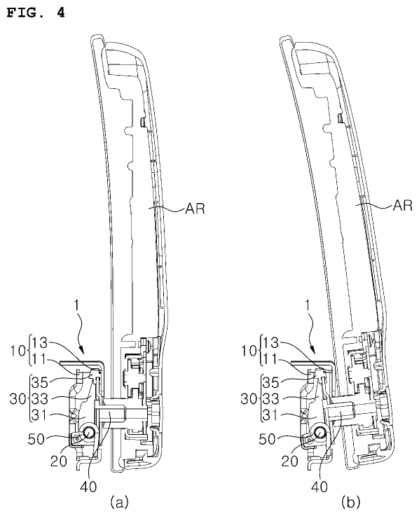

FIG. 3 is an exploded view of the armrest swing hinge device according to the embodiment.

With reference to FIG. 3, the bracket housing 10 is coupled to the side of the seat frame S and provided with a pivoting space therein, the pivoting space allowing the pivoting housing 30 to pivot. At this time, with further reference to FIG. 1, the height at which the bracket housing 10 is installed on the seat frame S is based on the average sitting height of the user when seated.

To describe the bracket housing 10 in detail, the bracket housing 10 includes a bracket housing main body 11 and may include a pivoting blocking plate 13.

With reference to FIGS. 2 to 3, the bracket housing main body 11 has opposite ends, which are coupled to a side surface of the seat frame S and have a predetermined height, thereby allowing the pivoting housing 30 to be installed at the inside thereof. In addition, for coupling between the armrest AR and the pivoting housing 30 at the outside (here, the outside is a direction in which the armrest swing hinge device 1 faces the armrest AR) and to allow the pivoting housing 30 to be pivoted at the inside based on the vertical shaft 20, the housing main body 11 has an opening toward the outside, the opening having an area corresponding to the pivoting housing main body 31.

The pivoting blocking plate 13 is provided on the outer front side of the bracket housing main body 11.

The vertical shaft 20 is disposed in the bracket housing 10 in a type of penetrating through the pivoting space in the up and down direction. Here, the bracket housing 10 may include a bushing 15 that surrounds a portion of the outer circumference of the vertical shaft 20 to facilitate pivoting of the vertical shaft 20 as well as to protect the area near the vertical shaft 20 from being damaged.

The pivoting housing 30 has a volume smaller than the pivoting space of the bracket housing 10 and is pivotably provided in the pivoting space of the bracket housing 10 in a state of being coupled to the vertical shaft 20.

With reference to FIGS. 1 to 2, the horizontal shaft 40 is provided perpendicular to the vertical shaft 20 on the outer surface of the pivoting housing 30, is exposed to the outside of the bracket housing 10, and is coupled to the armrest AR in a manner that orients the armrest AR to face forward.

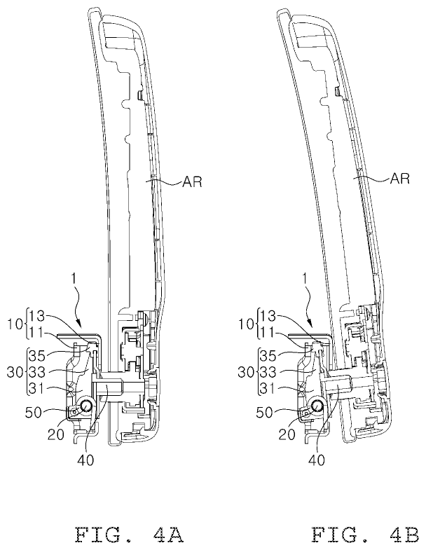

To describe the pivoting housing 30 in detail with reference to FIGS. 4A and 4B, which are each a sectional view showing the operation of the armrest swing hinge device 1, the pivoting housing 30 is disposed at the inside of the bracket housing 10, includes a pivoting housing main body 31, and may include a pivoting housing extension plate 33 (hereinafter referred to as “extension plate 33”).

The pivoting housing main body 31 is coupled to the vertical shaft 20 and is pivotable about the axis of the vertical shaft 20.

The extension plate 33 extends forward from the pivoting housing main body 31, is provided at the inside of the bracket housing 10, and comes into contact with the pivoting blocking plate 13 when pivoted outward based on the vertical shaft 20.

Ultimately, as the extension plate 33 and the pivoting blocking plate 13 come into contact, the angle at which the pivoting housing 30 may be pivoted in the bracket housing 10 based on the vertical shaft 20 is limited.

However, at least one of the pivoting blocking plate 13 and the extension plate 33 may be removed so that the front side of the pivoting housing 30 may be pivoted toward the outside based on the vertical shaft 20. In such a case where at least one of the pivoting blocking plate 13 and the extension plate 33 is removed, the armrest swing hinge device 1 may have a wider angle at which the pivoting housing 30 may be pivoted based on the vertical shaft 20.

The armrest swing hinge device 1 may include an elastic body 50.

The elastic body 50 is disposed, in a type of surrounding the outer circumference of the vertical shaft 20, at the inside of the pivoting housing 30 and has one side supporting the bracket housing 10 and an opposite side supporting the pivoting housing 30.

Therefore, when the pivoting housing 30 is pivoted inward based on the vertical shaft 20, the opposite side of the elastic body 50 presses the pivoting housing 30, whereby the extension plate 33 is moved to contact the pivoting blocking plate 13.

The pivoting housing 30 may include a damper 35 at an end part of the extension plate 33.

In the case where the extension plate 33 strongly contacts the pivoting blocking plate 13 by the elastic body 50 or the user, the damper 35 may prevent damage to the pivoting blocking plate 13 or the extension plate 33.

A process by which the armrest swing hinge device 1 is operated by the user will be described in detail.

The armrest swing hinge device 1 has a bracket housing 10) coupled to the side of the seat frame S, and the rear of the armrest AR is coupled to the horizontal shaft 40. For reference, the horizontal shaft 40 is provided on the pivoting housing 30.

With reference to FIGS. 1 and 2, when the user pivots the armrest AR up and down, the horizontal shaft 40 pivots together with the armrest AR.

With reference to FIG. 1 and FIGS. 4A and 4B, when the user pivots the armrest AR inward, the horizontal shaft 40 does not pivot, and the pivoting housing 30 pivots inward based on the vertical shaft 20. However, the pivoting housing 30 may pivot until the armrest AR contacts the outside of the pivoting blocking plate 13.

For example, in a process where another person moves to a seat of a third row when the user is sitting in a seat of a second row, the user may pivot the armrest AR inward through the armrest swing hinge device 1 to provide a wider movement path to another person moving to the seat of a third row through the passage where the seat of a second row is provided. In addition, in a state of pivoting the armrest AR inward, the user may also secure the armrest swing hinge device 1 not to pivot, thereby securing the armrest AR.

Expressions (terms, visualized images, and the like) used when describing the embodiments of the present disclosure are merely selected for the instrumental purpose of increasing understanding of the technology.

In addition, due to circumstances, the present disclosure has been described using a limited number of the embodiments, and those skilled in the art will be able to create new embodiments on the basis of the described embodiments without departing from the technical spirit of the present disclosure.

For example, although not shown in the drawings, in the case where at least one of the extension plate 33 and the pivoting blocking plate 13 is removed, the pivoting housing 30 may move further outward based on the vertical shaft 20, so the armrest AR may be pivoted at a wider angle based on the seat frame S through the armrest swing hinge device 1.

Therefore, the scope of the claims of the present disclosure should not be limited by some expressions shown in the “DETAILED DESCRIPTION” and “BRIEF DESCRIPTION OF THE DRAWINGS”, but should be broadly interpreted on the basis of the original technical idea inherent in the entire specification.

What is claimed is:

1. An armrest swing hinge device, the hinge device comprising:
a bracket housing coupled to a side of a seat frame and provided with a pivoting space therein;
a vertical shaft penetrating through the pivoting space of the bracket housing in an up and down direction;
a pivoting housing pivotably provided in the pivoting space of the bracket housing in a state of being coupled to the vertical shaft; and
a horizontal shaft provided perpendicular to the vertical shaft on an outer surface of the pivoting housing such that the horizontal shaft is exposed to the outside of the bracket housing, and is coupled to an armrest in a manner that orients the armrest to face forward.

2. The armrest swing hinge device of claim 1, wherein the pivoting housing comprises:
a pivoting housing main body coupled to the vertical shaft; and
a pivoting housing extension plate extended forward from the pivoting housing main body, and
the bracket housing comprises:
a bracket housing main body coupled to a side surface of the seat frame; and
a pivoting blocking plate extended forward from the bracket housing main body and configured to come into contact with the pivoting housing extension plate configured to pivot outward of the seat frame.

3. The armrest swing hinge device of claim 1, further comprising:
an elastic body disposed in the pivoting housing in a type of surrounding an outer circumference of the vertical shaft, the elastic body having one side supporting the bracket housing and an opposite side supporting the pivoting housing.

4. The armrest swing hinge device of claim 1, wherein the bracket housing comprises:
a bushing surrounding an outer circumference of the vertical shaft.

5. The armrest swing hinge device of claim 2, wherein the pivoting housing comprises:
a damper provided at an end part of the pivoting housing extension plate.
